(19) United States
(12) Patent Application Publication
(10) Pub. No.: US 2010/0013179 A1
(43) Pub. Date: Jan. 21, 2010

(54) Wheelbarrow tray

(76) Inventor: Liu Zhijun, Qingdao City (CN)

Correspondence Address: SANDRA LEE LIPKIN A LAW CORPORATION, P.O.Box 3518, VENTURA, CA, 93006, US

(21) Appl. No.: 12/218,649

(22) Filed: Jul. 16, 2008

(51) Int. Cl. B62B 1/18; B29C 45/26

(52) U.S. Cl. 280/47.31; 264/328.1

(57) ABSTRACT

An improved wheelbarrow tray that is formed as an integral unitary piece through the injection molding of polyethylene plastic. The improved tray does not include any holes in the bottom of the tray for bolting to the wheelbarrow frame, thereby eliminating a possible source of leakage when transporting powders or liquids. Furthermore, the bottom of the wheelbarrow tray, on the outside of the bowl portion, is located a strengthened protuberant bar that adds strength and provides a location for bolting the wheelbarrow tray to the wheelbarrow frame. The inclusion of protuberant bars on the bottom of the front end of the tray allows for easy dumping of loads while the plastic tray maintains its strength and shape, while liquids can be easily poured over the front of the wheelbarrow tray.

### BACKGROUND OF THE INVENTION

1. Field of the Invention

The present invention relates generally to the field of wheelbarrows, and particularly to an improved wheelbarrow tray that is easy to manufacture and made of a lightweight polyethylene plastic while providing the ability to transport liquids and powders with little to zero chance of leaking.

2. Description of the Prior Art

Typically, wheelbarrows are used to deliver a variety of materials with a corresponding variety of purposes and applications. The wheelbarrow consists of a tray that is attached to a transporting portion, typically consisting of one or more wheels, defined as the wheelbarrow frame. The tray bottoms of wheelbarrows in common use are flat. The flat bottom of the tray is attached to the transporting portion through holes found in the flat bottom that are bolted to the transporting portion. Because of the existence of these holes in the bottom of the wheelbarrow tray, it is risky to attempt to transport powders or liquids as the junction of the holes with the transporting portion offers a point of potential leakage of the transported material. Furthermore, protruding bolt heads in the body of the wheelbarrow tray creates obstructions when attempting to manipulate the contents therein.

Prior art has included US Patent Application 2008/0079228 to Rye et al. This application seeks to solve the problem of the protruding bolt heads by providing depressions in the tray. However, this does not alleviate the problem of creating points of leakage where the bolts are secured to the tray.

It is the object of the instant invention to overcome the shortcomings of the prior art.

It is the primary object of the instant invention to create a wheelbarrow tray that is formed as one piece, with complete integrity, made of polyethylene plastic through an injection molding process.

It is yet another object of the instant invention to provide a design of the unitary, integral wheelbarrow tray that includes a protuberant bar that provides both increased strength and a location for bolting the tray to the wheelbarrow frame.

### SUMMARY OF THE INVENTION

The preferred embodiment of the present invention teaches an improved integral one-piece wheelbarrow tray produced from an injection mold process comprising an interior portion for loading matter the interior portion being defined by a front wall, a rear wall, a first sidewall, a second sidewall, a bottom and upper rim extending around the front wall, the rear wall, the first sidewall and the second sidewall; a first member located on the bottom that extends in a direction substantially perpendicular from the bottom; a second member located on the bottom that extends in a direction substantially perpendicular from the bottom and substantially parallel to the first member; two apertures located in the first member for placement therethrough of a nut to be bolted to a wheelbarrow frame; and two apertures located in the second member for placement therethrough of a nut be bolted to a wheelbarrow frame.

The above embodiment can be further modified by defining that the wheelbarrow tray is made of polyethylene plastic.

The above embodiment can be further modified by defining that the wheelbarrow tray further comprises a third member located on the front wall proximate the upper rim that extends in a direction substantially perpendicular from the front wall; a fourth member located on the front wall proximate the upper rim that extends in a direction substantially perpendicular from the front wall and sits substantially parallel to the third member; an aperture located in the third member for placement therethrough of a nut to be bolted to a wheelbarrow frame; and an aperture located in the fourth member for placement therethrough of a nut to be bolted to a wheelbarrow frame.

An alternate embodiment of the instant invention teaches a method for producing an improved integral wheelbarrow tray comprising: molding through injection of a plastic a wheelbarrow tray further comprising an interior portion for loading matter the interior portion being defined by a front wall, a rear wall, a first sidewall, a second sidewall, a bottom and upper rim extending around the front wall, the rear wall, the first sidewall and the second sidewall; a first member located on the bottom that extends in a direction substantially perpendicular from the bottom; a second member located on the bottom that extends in a direction substantially perpendicular from the bottom and substantially parallel to the first member; two apertures located in the first member for placement therethrough of a nut to be bolted to a wheelbarrow frame; and two apertures located in the second member for placement therethrough of a nut be bolted to a wheelbarrow frame.

The above embodiment can be further modified by defining that the wheelbarrow tray is made of polyethylene plastic.

The above embodiment can be further modified by defining that the wheelbarrow tray further comprises a third member located on the front wall proximate the upper rim that extends in a direction substantially perpendicular from the front wall; a fourth member located on the front wall proximate the upper rim that extends in a direction substantially perpendicular from the front wall and sits substantially parallel to the third member; an aperture located in the third member for placement therethrough of a nut to be bolted to a wheelbarrow frame; and an aperture located in the fourth member for placement therethrough of a nut to be bolted to a wheelbarrow frame.

### BRIEF DESCRIPTION OF THE DRAWINGS

FIG. 1 is a bottom perspective view of the main base of the wheelbarrow tray.

FIG. 2 is a bottom perspective view of the entire base of the wheelbarrow tray.

FIG. 3 is a bottom perspective view of a second embodiment of the wheelbarrow tray.

FIG. 4 is a cross-sectional view of the wheelbarrow tray.

### DETAILED DESCRIPTION OF A PREFERRED EMBODIMENT

Turning to the drawings, the preferred embodiment is illustrated and described by reference characters that denote similar elements throughout the several views of the instant invention.

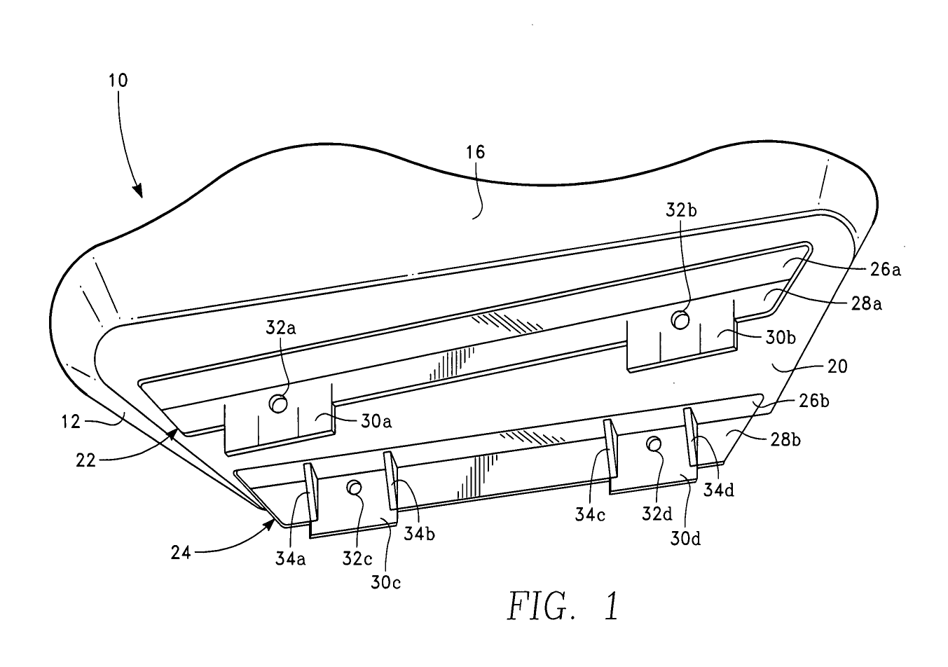

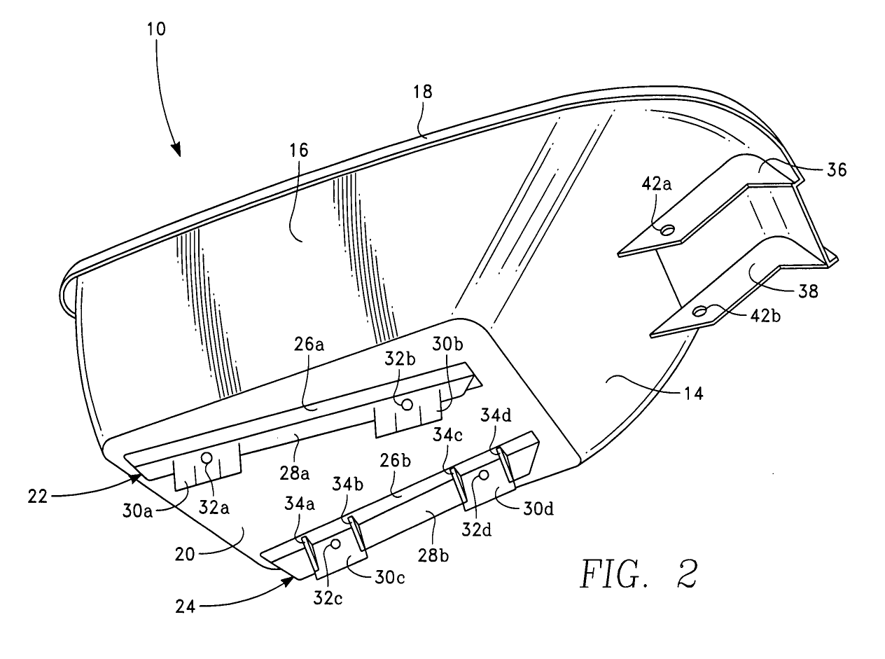

The preferred embodiment refers to a wheelbarrow tray 10 that can be seen in both FIGS. 1 and 2. Not shown in these views is the top view of the inside of the exterior of the tray 10 includes a rear wall 12, a front wall 14 and two sidewalls 16. As seen in FIG. 2, the tray 10 also includes a top rim 18 that extends around the periphery of the tray 10. The tray 10 also includes a bottom 20.

The bottom 20 of the tray 10 includes the first inventive aspect of the invention. It is to be remembered that the entire structure of the tray 10 is a solitary unit that is formed from the injection molding of polyethylene plastic. Part of the solitary unit in the preferred embodiment includes a first protuberant bar 22 and a second protuberant bar 24. Both the first protuberant bar 22 and the second protuberant bar 24 sit substantially parallel to each other.

Each protuberant bar 22, 24, includes a base 26a, 26b that supports an attaching member 28a, 28b that sits substantially perpendicular to the base 26a, 26b. The attaching member 28a, 28b includes one or more attachment points 30a, 30b, 30c, 30d that includes holes 32a, 32b, 32c, 32d. These attachment points 30a, 30b, 30c, 30d are strengthened with buttressing members 34a, 34b, 34c, 34d, 34e.

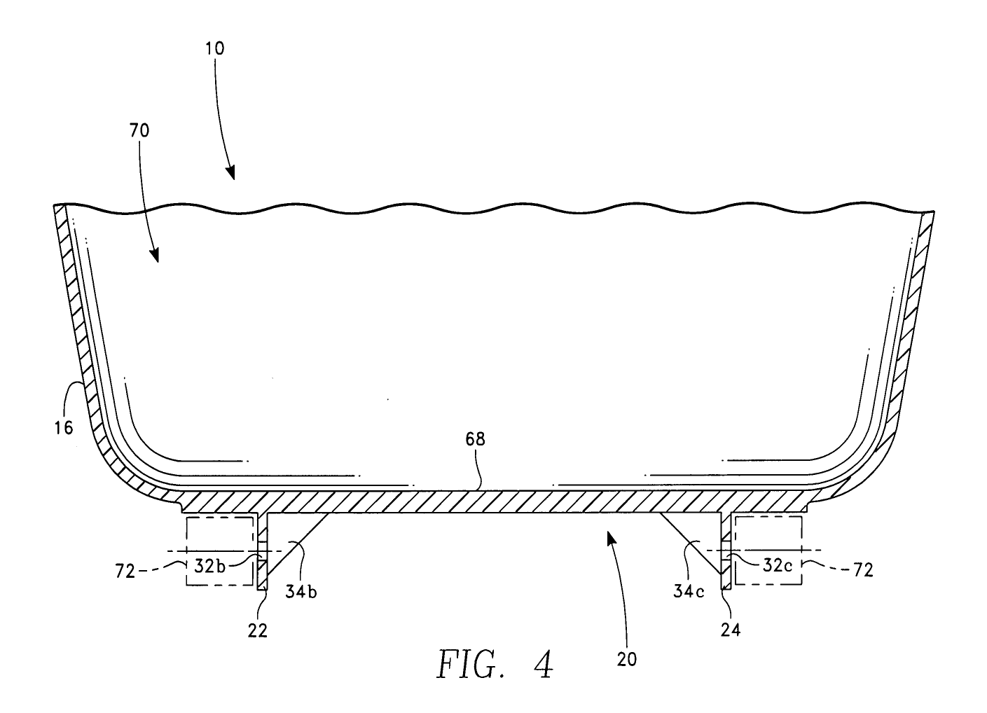

To secure to a wheelbarrow frame (shown in phantom in FIG. 4 depicted as numeral 72 is the wheelbarrow tray mounting hardware), the attaching members 28a, 28d are aligned with the frame. Bolts are fitted through the holes 32a, 32b, 32c, 32d and secured thereto. As a result, the tray is secured to the frame, but there are no points of potential leakage in the bowl of the wheelbarrow tray 10. FIG. 4 shows the interior bowl 70 and the clean internal bottom surface 68.

FIG. 2 shows the strengthened protuberances 36, 38 located on the front wall 14 of the tray 10, proximate the upper rim 18. These protuberances 36, 38 conform to the shape of the wheelbarrow tray 10 and include holes 42a, 42b for securing to the frame (not shown). The addition of the strengthened protuberances 36, 38 provides additional integrity to the shape of the tray when spilled forward to dump the contents found therein. With the addition of the strengthened protuberances 36, 38, the tray will not distort when manipulated into a position that allows for the dumping of the load.

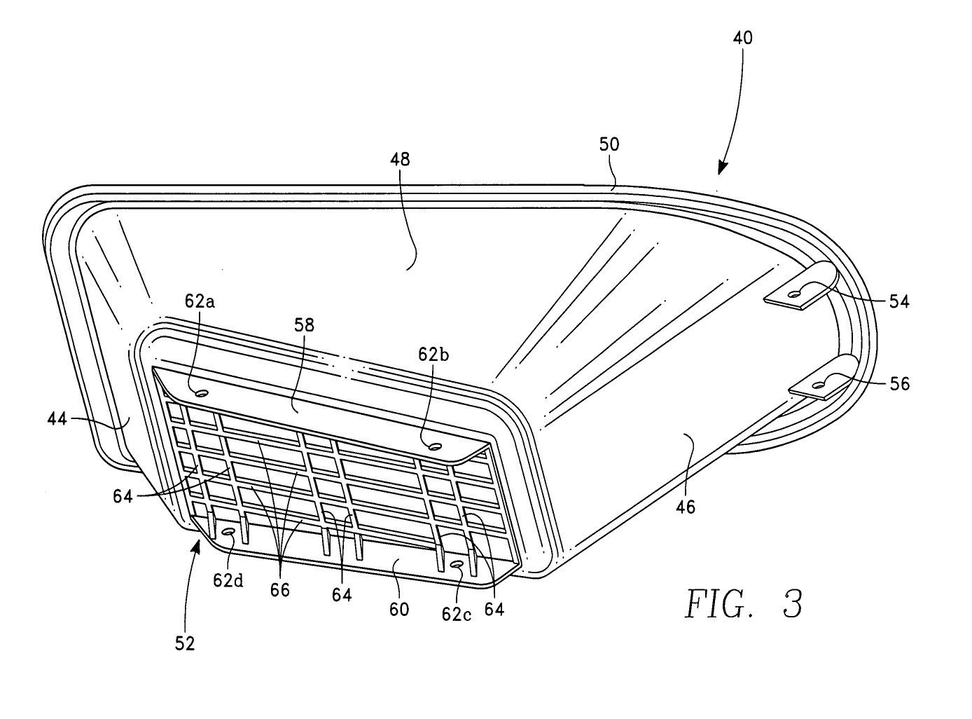

FIG. 3 illustrates an alternate embodiment of the wheelbarrow tray 40. The tray includes the rear wall 44, the front wall 46, two sidewalls 48, the upper rim 50 and the bottom 52. Above the front wall 46 and near the upper rim 50 are two protrusions 54, 56 that serve the purpose of helping to keep the integrity of the structure of the tray 40 when spilling liquids and/or powders from the front.

On the bottom 52 is the portion that includes the two protuberances 58, 60 that extend substantially perpendicular from the bottom 52 of the tray 40. Included on each protuberance 58, 60 are holes 62a, 62b, 62, 62d into which nuts are placed therein and bolted to a wheelbarrow frame. The protuberances 58, 60 are buttressed to the bottom 52 of the tray through a plurality of supports 64 that extend across the bottom 52 of the tray 40 from the first protuberance 58 to the other 60. Further reinforcing members 66 can be placed in a position perpendicular to the first plurality of supports 64.

The discussion included in this patent is intended to serve as a basic description. The reader should be aware that the specific discussion may not explicitly describe all embodiments possible and alternatives are implicit. Also, this discussion may not fully explain the generic nature of the invention and may not explicitly show how each feature or element can actually be representative or equivalent elements. Again, these are implicitly included in this disclosure. Where the invention is described in device-oriented terminology, each element of the device implicitly performs a function. It should also be understood that a variety of changes may be made without departing from the essence of the invention. Such changes are also implicitly included in the description. These changes still fall within the scope of this invention.

Further, each of the various elements of the invention and claims may also be achieved in a variety of manners. This disclosure should be understood to encompass each such variation, be it a variation of any apparatus embodiment, a method embodiment, or even merely a variation of any element of these. Particularly, it should be understood that as the disclosure relates to elements of the invention, the words for each element may be expressed by equivalent apparatus terms even if only the function or result is the same. Such equivalent, broader, or even more generic terms should be considered to be encompassed in the description of each element or action. Such terms can be substituted where desired to make explicit the implicitly broad coverage to which this invention is entitled. It should be understood that all actions may be expressed as a means for taking that action or as an element which causes that action. Similarly, each physical element disclosed should be understood to encompass a disclosure of the action which that physical element facilitates. Such changes and alternative terms are to be understood to be explicitly included in the description.

What is claimed is:

1. An improved integral one-piece wheelbarrow tray produced from an injection mold process comprising
an interior portion for loading matter said interior portion being defined by a front wall, a rear wall, a first sidewall, a second sidewall, a bottom and upper rim extending around said front wall, said rear wall, said first sidewall and said second sidewall;
a first member located on said bottom that extends in a direction substantially perpendicular from said bottom;
a second member located on said bottom that extends in a direction substantially perpendicular from said bottom and substantially parallel to said first member;
two apertures located in said first member for placement therethrough of a nut to be bolted to a wheelbarrow frame; and
two apertures located in said second member for placement therethrough of a nut be bolted to a wheelbarrow frame.

2. The wheelbarrow tray as defined in claim 1 wherein said wheelbarrow tray is made of polyethylene plastic.

3. The wheelbarrow tray as defined in claim 1 wherein said wheelbarrow tray further comprises
a third member located on said front wall proximate said upper rim that extends in a direction substantially perpendicular from said front wall;
a fourth member located on said front wall proximate said upper rim that extends in a direction substantially perpendicular from said front wall and sits substantially parallel to said third member;
an aperture located in said third member for placement therethrough of a nut to be bolted to a wheelbarrow frame; and
an aperture located in said fourth member for placement therethrough of a nut to be bolted to a wheelbarrow frame.

4. A method for producing an improved integral wheelbarrow tray comprising:
molding through injection of a plastic a wheelbarrow tray further comprising
an interior portion for loading matter said interior portion being defined by a front wall, a rear wall, a first sidewall, a second sidewall, a bottom and upper rim extending around said front wall, said rear wall, said first sidewall and said second sidewall;
a first member located on said bottom that extends in a direction substantially perpendicular from said bottom;
a second member located on said bottom that extends in a direction substantially perpendicular from said bottom and substantially parallel to said first member;
two apertures located in said first member for placement therethrough of a nut to be bolted to a wheelbarrow frame; and
two apertures located in said second member for placement therethrough of a nut be bolted to a wheelbarrow frame.

5. The method as defined in claim 4 wherein said wheelbarrow tray is made of polyethylene plastic.

6. The method as defined in claim 4 wherein said wheelbarrow tray further comprises
a third member located on said front wall proximate said upper rim that extends in a direction substantially perpendicular from said front wall;
a fourth member located on said front wall proximate said upper rim that extends in a direction substantially perpendicular from said front wall and sits substantially parallel to said third member;
an aperture located in said third member for placement therethrough of a nut to be bolted to a wheelbarrow frame; and
an aperture located in said fourth member for placement therethrough of a nut to be bolted to a wheelbarrow frame.
